(19) United States
(12) Patent Application Publication
(10) Pub. No.: US 2003/0031094 A1
(43) Pub. Date: Feb. 13, 2003

(54) Clock and frame assembly and clock structure for use therewith

(76) Inventors: Akira Banno, Kowloon (HK); Leung Kam Kwei, Kowloon (HK)

Correspondence Address: ADAMS & WILKS, ATTORNEY AND COUNSELORS AT LAW, 31st FLOOR, 50 BROADWAY, NEW YORK, NY, 10004, US

(21) Appl. No.: 10/216,414

(22) Filed: Aug. 9, 2002

(30) Foreign Application Priority Data
Aug. 10, 2001 (JP) 243918/2001

(51) Int. Cl. G04C 23/02; G04B 37/00

(52) U.S. Cl. 368/88

(57) ABSTRACT

A clock and frame assembly has an outer frame having a mounting hole extending therethrough from a front surface of the outer frame to a rear surface thereof. A clock unit for keeping and displaying time is inserted into the mounting hole from the front of the outer frame and has a clock case directly contacting the front surface of the outer frame. A mounting unit engages with the rear surface of the outer frame and extends into the mounting hole toward the clock unit. The mounting unit is detachably connected to the clock unit to thereby removably mount the clock unit to the outer frame. The detachable connection between the mounting unit and the clock unit is manually adjustable to enable tightening or loosening of the connection to thereby adjust the pressure at which the clock unit contacts the front surface of the outer frame.

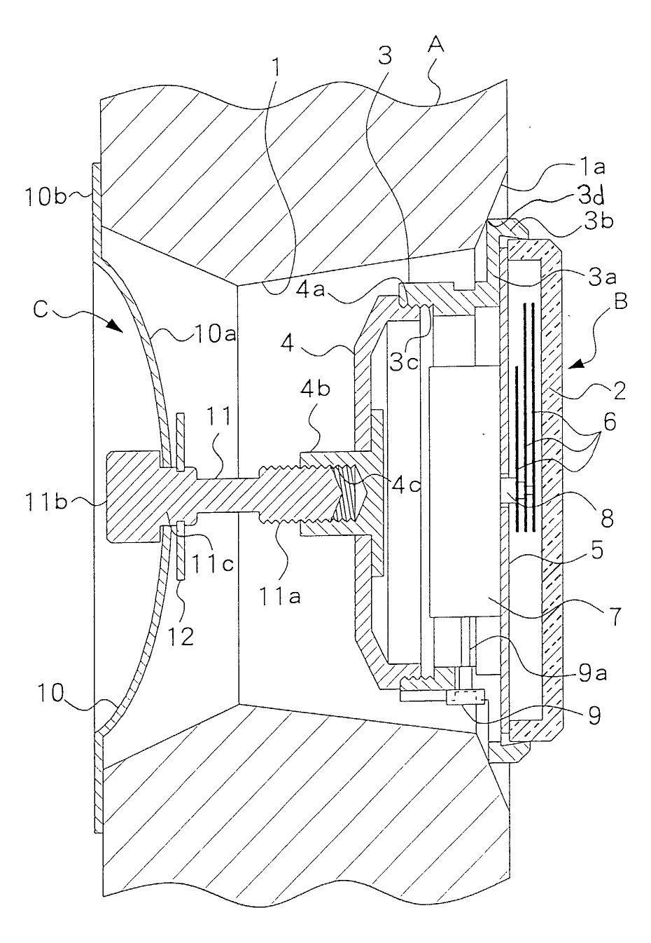

### BACKGROUND OF THE INVENTION

1. Field of the Invention

The present invention relates generally to a clock and frame assembly and, more particularly, to a clock unit that can be removably mounted to an outer frame by a mounting unit to form a clock and frame assembly.

2. Description of the Related Art

There are known outer frames formed of various raw materials, such as wood, crystal and the like, in which a clock unit is removably mounted to form a clock and frame assembly, and a user typically selects a particular outer frame according to his personal preference. To enable the clock unit to be used with an outer frame formed of any arbitrarily selected raw material, it is preferable that the clock unit have a common structure. Clock units having a common structure can be fitted into any one of the mounting holes made in common in various kinds of outer frames thereby providing a variety of styles of clock and frame assemblies having different outer frames though common clock units.

One such clock unit has been proposed by the applicant of the present application in Japanese Patent Application No. 99862/2001. As described in the Japanese application, in order to mount the clock unit to the outer frame, a packing is press-fitted in a compressed state in a mounting recess of the outer frame. An outer circumferential surface of the packing and an inner circumferential surface of the mounting recess are brought into pressure contact with each other due to the elastic force of the packing, and a thick portion of the packing is fitted in a recess formed between a rear surface of the clock case and an edge portion of the rear cover of the clock case. Once the clock unit is mounted to the outer frame, the clock unit is firmly combined therewith and does not easily separate from the outer frame.

In the clock unit described in Japanese Patent Application No. 99862/2001, the clock unit is held in the mounting hole provided in the outer frame by the elastic force of the packing which is press-fitted in a compressed state in the outer frame. However, when the outer frame is made of certain raw materials, such as, for example, earthenware which has a relatively large dimensional tolerance, the variations in the diameter of the mounting hole formed in the outer frame and in the thickness of the outer frame among different frames are relatively large. Therefore, the clock unit is not always reliably held in the mounting hole of the outer frame by the elastic force of the packing, whereupon the clock unit sometimes separates from the outer frame during transporting of the clock and frame assembly.

### SUMMARY OF THE INVENTION

Therefore, it is a principal object of the present invention to provide a clock and frame assembly having a clock unit which is reliably held in an outer frame so that the clock unit does not separate therefrom during transporting of the clock and frame assembly even when a raw material having a large dimensional tolerance is used for the outer frame.

Another object of the present invention is to provide a clock and frame assembly in which the clock unit is easily and securely mounted to the outer frame.

A further object of the present invention is to provide a clock and frame assembly having a clock unit which can be inserted in a mounting through-hole of an outer frame and removably mounted to the outer frame despite wide variations in tolerance of the mounting hole and thickness of the outer frame.

Another object of the present invention is to provide a clock structure having a clock unit and a mounting unit and which can be interchangeably used with any one of a plurality of different outer frames.

The above and other objects of the present invention are realized by an outer frame having a mounting hole extending therethrough from the front surface to the rear surface, a clock unit insertable into the mounting hole from the front of the outer frame and directly contacting an inclined surface formed on the front surface of the outer frame, and a mounting unit insertable into the mounting hole from the rear of the outer frame for mounting the clock unit to the outer frame.

The mounting unit preferably has a collar portion engageable with the rear surface of the outer frame in a region surrounding the mounting hole, and a fixing screw which extends into the mounting hole and which is threadedly connected to a case back of the clock unit so that turning of the fixing screw draws the mounting unit and the clock unit closer together, thereby pressing the case of the clock unit against the front surface of the outer frame and pressing the collar portion against the rear surface of the outer frame to thereby securely fix the clock unit to the outer frame. The case of the clock unit and the collar portion of the mounting unit are pressed firmly against portions of the front and rear surfaces of the outer frame which surround the mounting hole so that even when a raw material of a large dimensional tolerance is used for the outer frame, the clock unit may be securely mounted to the outer frame and will not separate therefrom during transporting of the clock and frame assembly.

The portion of the front surface of the outer frame which surrounds the mounting hole is preferably provided with an inclined surface which terminates at the mounting hole, and a circumferential region of the case of the clock unit preferably directly contacts the inclined surface of the outer frame. Owing to this arrangement, the clock unit can be securely mounted to outer frames of different thicknesses since the circumferential region of the case may be brought into contact with the outer frame anywhere along the length of the inclined surface.

### BRIEF DESCRIPTION OF DRAWING

The single FIGURE of drawing is a cross-sectional view of a clock and frame assembly constructed according to the principles of the present invention.

### DETAILED DESCRIPTION OF THE INVENTION

A preferred embodiment of the present invention will be described with reference to the single FIGURE of drawing.

The clock and frame assembly comprises an outer frame A, a clock unit B removably inserted into a mounting hole in the outer frame A, and a mounting unit C for detachably mounting the clock unit B to the outer frame A.

The outer frame A may be formed of any desired material, such as wood, crystal, earthenware or the like, and may have any desired size and shape. In the embodiment shown in the drawing, the outer frame A is formed of earthenware. In accordance with the invention, the user may have a plurality of different outer frames A and select different ones for use at different times depending, for example, on the decor of the room in which the clock and frame assembly is being used. The outer frame A has a mounting through-hole 1 extending therethrough from the front side (right side in the FIGURE) to the rear side. The front surface of the outer frame A is provided with an inwardly tapered recessed portion which defines an inclined surface 1a surrounding the mounting hole 1. While in the embodiment shown in the drawing the inclined surface 1a terminates at the mounting hole 1, the inclined surface 1a may instead be formed in the front surface of the outer frame A at a location spaced from the mounting hole 1.

The clock unit B includes a crystal 2, a case 3 and a case back 4. A dial plate 5 is firmly held between the crystal 2 and the case 3. A set of time-indicating hands 6, such as hour, minute and second hands, are disposed in the space between the crystal 2 and the dial plate 5. A movement 7 is fixed to a rear surface of the dial plate 5 and rotationally drives a set of hand shafts 8, such as hour hand, minute hand and second hand shafts, to rotationally drive the time-indicating hands 6 to indicate time. The hand shafts 8 extend through an opening in the dial plate 5 and are fixed to end portions of the hands 6. In this manner, the timepiece 7 rotationally drives the hands 6 in timed relation to keep and display time. A crown shaft 9a projects from a side surface of the movement 7, and a crown 9 is fixed to an end of the crown shaft 9a which projects out of the case 3. Though the clock unit B has been described with reference to an analog clock, it is understood that the clock unit B may, if desired, be a digital clock.

The case 3 is preferably made of metal and is provided at a front region thereof with a dial plate retaining section 3a and a crystal locking section 3b which extends forwardly from the outer circumference of the dial plate retaining section 3a. The dial plate retaining section 3a contacts a rear surface of an outer circumferential part of the dial plate 5, and the crystal locking section 3b tightly engages with an outer circumferential surface of the crystal 2. The angular portion of the case 3 where the dial plate retaining section 3a connects with the crystal locking section 3b defines a circumferential edge 3d of the case 3 which directly contacts the inclined surface 1a of the outer frame A. The case 3 is provided with a female thread 3c in a rear end region of an inner circumferential surface thereof.

The case back 4 is also preferably made of metal and is provided in an outer circumferential surface of a front end portion thereof with a male thread 4a. The male thread 4a is threadedly engaged with the female thread 3c to removably connect the case back 4 to the case 3. A metal bushing 4b extends through a central opening in the case back 4 and is permanently fixed to the case back 4, such as by ultrasonic fusing. The portion of the bushing 4b which projects outwardly from the case back 4 has a central opening provided with a female thread 4c.

The mounting unit C is also preferably formed of metal and comprises a metal rear cover 10, and a manually turnable metal fixing screw 11 rotatably mounted on the rear cover 10. The rear cover 10 has a spherically recessed portion boa at a central region thereof, and a flange or collar portion 10b at an outer circumferential region thereof. The flange or collar portion lob engages with a rear surface portion of the outer frame A which surrounds the mounting through-hole 1. The manually turnable fixing screw 11 has a male thread 11a at a front end portion thereof, the male thread 11a being threadedly engaged with the female thread 4c of the bushing 4b. The male and female threads 11a, 4c comprise complementary connecting portions which are connectable together to mount the clock unit B on the outer frame A. An operating knob 11b is provided at the rear end portion of the fixing screw 11, and the outer circumferential surface of the operating knob 11b is suitably knurled to enable the knob to be easily manually gripped and turned. The fixing screw 11 has a fixing portion 11c which is rotatably inserted in a central hole formed in the recessed portion 10a of the rear cover 10, and the fixing screw 11 is joined to the rear cover 10 by a ring member 12 so that the rear cover 10 is sandwiched between the ring member 12 and the operating knob 11b. By such a construction, the fixing screw 11 can be manually rotated in either direction to loosen or tighten the threaded connection between the male and female threads 11a, 4c though the fixing screw 11 remains joined to the rear cover 10. The operating knob 11b is preferably positioned within the recessed portion 10a so as not to project beyond the rear surface of the outer frame A.

The manner of assembling the clock and frame assembly will next be described. The outer frame A is manufactured using any suitable material and having any desired size and shape. The clock unit B is assembled by connecting the crystal 2 to the case 3 with the dial plate 5 sandwiched therebetween, the movement 7 and the hands 6 being previously affixed to the dial plate 5. Then the case back 4 is threaded onto the case 3 to complete assembly of the clock unit B. The mounting unit C is assembled by securing the fixing screw 11 to the rear cover 10 by means of the ring member 12. The clock unit B is then inserted from the front of the outer frame A into the mounting through-hole 1 until the circumferential edge 3d of the case 3, i.e., the angular portion of the case 3 between the dial plate retaining section 3a and the crystal locking section 3b, is brought into direct contact with the inclined surface 1a at the front of the outer frame A.

Then the mounting unit C is inserted from the rear of the outer frame A into the mounting through-hole 1 such that the fixing screw 11 is aligned with the central opening in the bushing 4b. The operating knob 11 is manually turned so as to screw the male thread 11a of the fixing screw 11 into the female thread 4c of the case back 4. As the fixing screw is tightened, the clock unit B and the mounting plate C are brought closer together, and the collar portion lob of the rear cover 10 firmly engages with the rear surface of the outer frame A which surrounds the mounting hole 1 and the circumferential edge 3d of the case 3 is pressed firmly against the inclined surface 1a formed at the front surface of the outer frame A. The contact pressure between the clock unit B and the outer frame A, i.e., the contact pressure between the circumferential edge 3d of the case 3 and the inclined surface 1a of the outer frame A, can be easily adjusted by tightening or loosening the threaded connection of the male and female threads 11a, 4b, and thus the clock unit B can be reliably fixed in the outer frame A.

In accordance with the present invention, even when the dimensional tolerance of the thickness of the outer frame A is large, the clock unit B can be fixed stably and reliably in the outer frame A as long as the dimensional tolerance is within a range that enables the circumferential edge 3d of the case 3 to be displaced within the range of the inclined surface 1a and the collar portion 10b to be engaged with the rear surface of the outer frame A surrounding the mounting hole 1. This greatly reduces the need for precise machining accuracy in forming the mounting hole 1 in the outer frame A and ensures that the clock unit B is reliably secured to the outer frame A. Moreover, by forming the case back 4, rear cover 10 and fixing screw 11 of metal, these parts can withstand sufficient screw-tightening forces to reliably secure the clock unit B to the outer frame A.

The inventive construction also enables easy replacement of a battery used for powering the clock and which is typically mounted in the movement 7. In order to replace the battery, the fixing screw 11 is unscrewed from the bushing 4b of the case back 4 to disconnect the clock unit B from the mounting unit C. The clock unit B is then removed from the outer frame A, and the case 3 and case back 4 are unscrewed from one another and separated so that the battery mounted in the movement 7 can be replaced with a new battery.

In the embodiment shown in the drawing, the circumferential edge 3d of the case 3 directly contacts the inclined surface 1a which opens into the through-hole 1. The present invention is not limited to such a construction, and the tapered opening which defines the inclined surface 1a may be spaced and separated from the through-hole 1 so that the circumferential edge 3d of the case 3 contacts an inclined surface formed in the outer frame A which is spaced from the through-hole 1. Moreover, while the case back 4 is shown threadedly connected to the case 3, these parts may be releasably connected together by other means, such as a snap-fit, screws or the like.

In the clock and frame assembly according to the present invention, the clock unit is removably mounted under pressure to the outer frame with the case of the clock unit in direct contact with a portion of the front surface of the outer frame which surrounds the mounting hole and with the collar portion of the mounting unit engaged with a portion of the rear surface of the outer frame which surrounds the mounting hole. Therefore even when an outer frame having a large dimensional tolerance is used, the clock unit can be fixed reliably to the outer frame, and the clock unit will not shift relative to the outer frame or slip off of the outer frame during transporting of the clock and frame assembly. Since the circumferential edge of the case makes direct contact with the inclined surface of the outer frame, variations in the thickness of the outer frame can be coped with easily. Moreover, by virtue of the threaded connection between the case and the case back, the two parts can be easily separated from one another to facilitate battery replacement.

While the present invention has been described with respect to preferred embodiments thereof, it is understood that minor modifications and variations will be apparent to those ordinarily skilled in the art. The present invention is not limited to the embodiments described, and the invention covers all such modifications and variations falling within the scope of the appended claims.

We claim:

1. A clock structure removably mountable in a through-hole provided in an outer frame, the clock structure comprising: a clock unit for keeping and displaying time, the clock unit being insertable into the through-hole from a front of the outer frame and having a case directly contactable with a surface of the outer frame when the clock unit is inserted in the through-hole; and a mounting unit engageable with a rear of the outer frame and extendable into the through-hole toward the clock unit, the mounting unit having a connecting portion detachably connectable to a complementary connecting portion of the clock unit to thereby removably mount the clock unit to the outer frame.

2. A clock structure according to claim 1; wherein the clock unit has a case back connected to the case, the complementary connecting portion of the clock unit being connected to and projecting outwardly of the case back.

3. A clock structure according to claim 2; wherein the detachable connection between the connecting portion of the mounting unit and the complementary connecting portion of the clock unit is manually adjustable to enable tightening or loosening of the connection to thereby adjust the pressure at which the clock unit contacts the surface of the outer frame.

4. A clock structure according to claim 1; wherein the mounting unit has a collar portion engageable with the rear of the outer frame, and a recessed portion connected to the collar portion and extendable into the through-hole, the connecting portion of the mounting unit being connected to the recessed portion.

5. A clock structure according to claim 4; wherein the collar portion, recessed portion, connecting portion and complementary connecting portion are comprised of metal.

6. A clock and frame assembly comprising: an outer frame having a mounting hole extending therethrough from a front surface of the outer frame to a rear surface thereof; a clock unit inserted into the mounting hole and directly contacting the front surface of the outer frame; and a mounting unit engaged with the rear surface of the outer frame and extending into the mounting hole toward the clock unit, the mounting unit being detachably connected to the clock unit to urge the clock unit into pressure contact with the front surface of the outer frame to thereby removably mount the clock unit to the outer frame.

7. A clock and frame assembly according to claim 6; wherein the outer frame has an inclined surface surrounding the mounting hole, the clock unit directly contacting the inclined surface.

8. A clock and frame assembly according to claim 7; wherein the inclined surface is inwardly inclined and terminates at its inward end at the mounting hole.

9. A clock and frame assembly according to claim 7; wherein the mounting unit has a turnable screw extending into the mounting hole and threadedly engaged with the clock unit so that turning of the screw in a tightening direction increases the pressure contact between the clock unit and the inclined surface of the outer frame.

10. A clock and frame assembly according to claim 9; wherein the clock unit has a case having a circumferential edge, the circumferential edge being in pressure contact with the inclined surface of the outer frame.

11. A clock and frame assembly according to claim 9; wherein the mounting unit has a flange portion engaged with the rear surface of the outer frame, and a recessed portion connected to the flange portion and extending into the mounting hole, the turnable screw being turnably mounted on the recessed portion.

12. A clock and frame assembly according to claim 9; wherein the clock unit has a case having a circumferential edge in pressure contact with the inclined surface of the outer frame, and a case back removably connected to a rear of the case, the turnable screw being threadedly engaged with the case back.

13. A clock and frame assembly according to claim 12; wherein the case back is threadedly connected to the case.

14. A clock and frame assembly according to claim 12; wherein the case back, flange portion, recessed portion and screw are made of metal.

15. A clock and frame assembly according to claim 6; wherein the mounting unit has a turnable screw extending into the mounting hole and threadedly engaged with the clock unit so that turning of the screw in a tightening direction increases the pressure contact between the clock unit and the front surface of the outer frame.

16. A clock and frame assembly according to claim 15; wherein the clock unit has a case having a circumferential edge, the circumferential edge being in pressure contact with the front surface of the outer frame.

17. A clock and frame assembly according to claim 15; wherein the mounting unit has a flange portion engaged with the rear surface of the outer frame, and a recessed portion connected to the flange portion and extending into the mounting hole, the turnable screw being turnably mounted on the recessed portion.

18. A clock and frame assembly according to claim, 15; wherein the clock unit has a case having a circumferential edge in pressure contact with the front surface of the outer frame, and a case back removably connected to a rear of the case, the turnable screw being threadedly engaged with the case back.

19. A clock and frame assembly according to claim 18; wherein the case back is threadedly connected to the case.

20. A clock and frame assembly according to claim 18; wherein the case back, flange portion, recessed portion and screw are made of metal.
